(19) United States
(12) Patent Application Publication
(10) Pub. No.: US 2020/0125959 A1
(43) Pub. Date: Apr. 23, 2020

(54) Autoencoder Neural Network for Signal Integrity Analysis of Interconnect Systems

(71) Applicant: Intel Corporation, Santa Clara, CA (US)

(72) Inventors: Wendemegagnehu T. Beyene, San Jose, CA (US); Juhitha Konduru, Urbana, IL (US)

(73) Assignee: Intel Corporation, Santa Clara, CA (US)

(21) Appl. No.: 16/720,318

(22) Filed: Dec. 19, 2019

(51) Int. Cl. G06N 3/08; G06N 3/04

(52) U.S. Cl. CPC G06N 3/088; G06N 3/04

(57) ABSTRACT

Autoencoder circuitry for generating a compact macromodel of an interconnect system is provided. The autoencoder circuitry may include an encoder portion having a reduced model generator configured to receive an original complex macromodel and to output a corresponding latent space representation. The autoencoder circuitry may further include a decoder portion having a complex model reconstruction generator configured to receive the latent space representation and to output a corresponding reconstructed output macromodel. The autoencoder circuitry may also include associated control circuitry for performing clustering and training operations to ensure that the reconstructed output macromodel converges with the original complex macromodel. Once training is complete, the latent space or the compact representation may be used as the compact model for use in performing desired frequency domain or time domain analysis and simulation of the interconnect system.

### BACKGROUND

This relates generally to integrated circuits and more particularly, to interconnect structures that couple together one or more integrated circuits.

Integrated circuits are often coupled to one another via a high speed interface. As the interface speed requirements continue to increase from one generation to the next, the analysis and simulation of interconnect systems for both parallel and serial links are becoming more challenging and time consuming. The types of interconnect systems that need to be analyzed might include electrical paths within an integrated circuit die, electrical paths between multiple dies on a single multichip package, electrical paths between different packages on a board, electrical paths linking different boards, electrical paths linking different systems, etc.

The analysis of complex high speed links is often carried out using transistor-level simulation tools that include both the transmitter and receiver components. Conventionally, these analyses are performed in the time domain using a time-consuming approach using time marching methods. To facilitate the analysis, interconnect systems are typically represented using a complex high-order model. Analyzing interconnect systems in the time domain without some reliable method of reducing the order of the complex model to some simpler low-order model for subsequent time domain simulation results in extreme inefficiency and inaccuracy.

It is within this context that the embodiments described herein arise.

### BRIEF DESCRIPTION OF THE DRAWINGS

FIG. 1 is a diagram of an illustrative system of integrated circuit devices operable to communicate with one another in accordance with an embodiment.

FIG. 2 is a diagram showing different types of interconnect structures in accordance with an embodiment.

FIG. 3 is a diagram of an illustrative equivalent circuit model of an interconnect path in accordance with an embodiment.

FIG. 4 is a diagram of illustrative frequency-domain analysis tools implemented on a circuit design system configured to perform analysis and simulation based on a complex macromodel or a compact macromodel in accordance with an embodiment.

FIGS. 5A and 5B are diagrams illustrating the frequency response of a channel represented using a high-order model and a low-order model in accordance with an embodiment.

FIG. 6 is a diagram of illustrative autoencoder circuitry configured to generate compact models for enabling efficient and accurate signal and power integrity analysis of high-speed interconnect systems in accordance with an embodiment.

FIG. 7A is a diagram illustrating the poles of a complex interconnect model in accordance with an embodiment.

FIG. 7B is a diagram illustrating the poles of a simple interconnect model reduced via clustering in accordance with an embodiment.

FIG. 8 is a diagram showing the reduction/encoding of an input layer to generate a corresponding hidden layer and the reconstruction/decoding of the hidden layer in accordance with an embodiment.

FIG. 9 is a flow chart of illustrative steps involved in operating the autoencoder of the type shown in at least FIGS. 6-8 in accordance with an embodiment.

### DETAILED DESCRIPTION

The present embodiments relate to an autoencoder neural network that uses unsupervised learning to generate compact models for analysis and simulation of high-speed interconnect systems. Interconnect systems may be represented using a complex model obtained using a rational approximation method. The autoencoder may then construct a compact model by extracting, from the complex model, the most significant information that is needed to efficiently characterize the interconnect system in the frequency domain. Analyzing interconnect structures using artificial intelligence (AI) based modeling in this way offers significantly faster simulation and design times with sufficient accuracy and reliability. For instance, simulation and design processes that previously took days or weeks can now be completed in just a few minutes. The techniques described herein does not require domain expertise and is independent of the complexity of the interconnect system.

It will be recognized by one skilled in the art, that the present exemplary embodiments may be practiced without some or all of these specific details. In other instances, well-known operations have not been described in detail in order not to unnecessarily obscure the present embodiments.

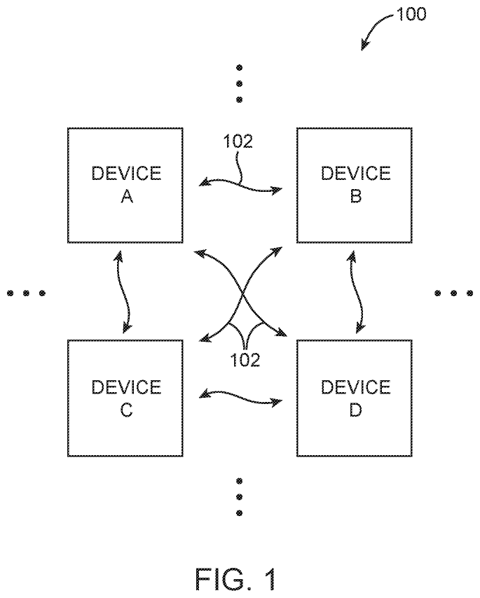

FIG. 1 is a diagram of an illustrative system 100 of interconnected electronic devices. A system such as system 100 of interconnected electronic devices may have multiple electronic devices such as device A, device B, device C, device D, and interconnection resources 102. Interconnection resources 102 such as conductive lines and busses, optical interconnect infrastructure, or wired and wireless networks with optional intermediate switching circuitry may be used to send signals from one electronic device to another electronic device or to broadcast information from one electronic device to multiple other electronic devices. For example, a transmitter in device B may transmit data signals to a receiver in device C. Similarly, device C may use a transmitter to transmit data to a receiver in device B.

The electronic devices may be any suitable type of electronic device that communicates with other electronic devices. Examples of such electronic devices include integrated circuits having electronic components and circuits such as analog circuits, digital circuits, mixed-signal circuits, circuits formed within a single package, circuits housed within different packages, circuits that are interconnected on a printed-circuit board (PCB), circuits mounted on different circuit boards, etc.

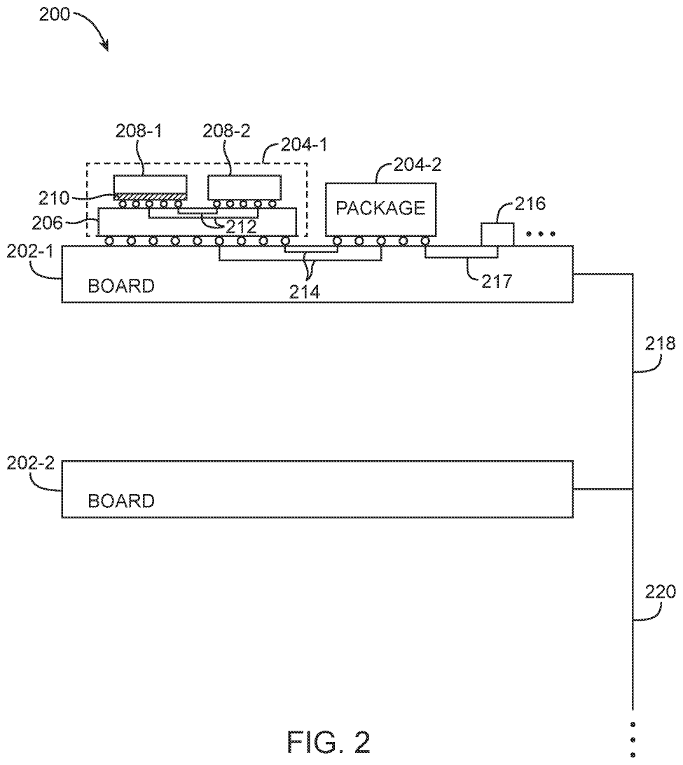

FIG. 2 is a diagram of a system 200 showing different types of interconnect structures in accordance with an embodiment. As shown in FIG. 2, multiple integrated circuit (IC) packages such as packages 204-1 and 204-2 may be mounted on a circuit board such as printed circuit board 202-1. Package 204-1 may (as an example) be a multichip package that includes at least a first integrated circuit die 208-1 and a second integrated circuit die 208-2 mounted on a shared package substrate 206. In other suitable arrangements, multichip package 204-1 may include more than two integrated circuit dies (e.g., multiple dies stacked vertically on top of one another, at least three components mounted laterally on a common substrate, or some combination of vertical and lateral mounting). Package 204-1 that is also mounted on circuit board 202-1 may be a single-chip package (i.e., a package with only a single integrated circuit die) or a multichip package. In the example of FIG. 2, other components such as component 216 (e.g., a discrete capacitor component, a discrete inductor component, a discrete resistor component, a voltage regulator module, etc.) may also be mounted on board 202-1.

System 200 illustrates how there are many different types of interconnect structures. For instance, IC die 208-1 may include metal routing lines and vias in a dielectric stack 210, which represent a first type of interconnect path used to couple one transistor to another within die 208-1. Conductive paths 212 formed in package substrate 206 may represent a second type of interconnect path used to couple together different IC chips within a single package. Transmission lines 214 and 217 formed in board 202-1 may represent a third type of interconnect path used to couple together different IC packages or components mounted on the same circuit board. Conductive buses 218 and 220 may represent yet another type of interconnect path used to couple together different circuit boards in the same or different system/subsystem. These different types of interconnect structures may be configured to distribute power if part of a power distribution network or to transmit signals within a single chip, between multiple chips, between different packages, between different circuit boards, and/or between different electronic systems.

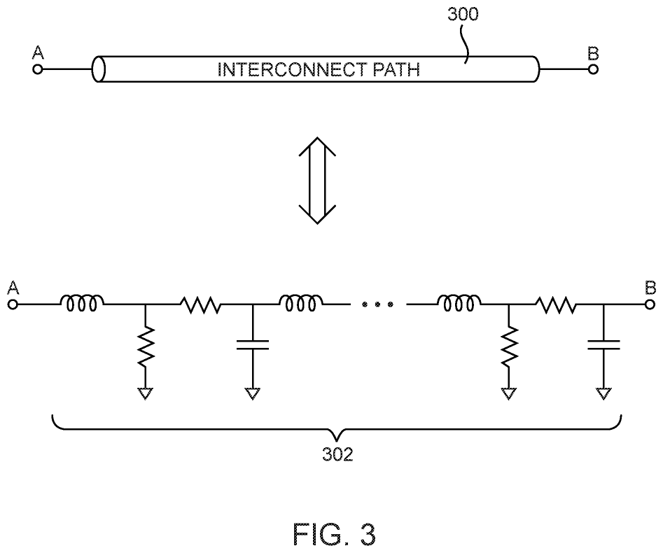

Any type of interconnect system can be represented by an equivalent circuit model. FIG. 3 is a diagram of an illustrative equivalent circuit model 302 of an interconnect path 300. Interconnect path 300 may have a first terminal connected to point A and a second terminal connected to point B. As shown in FIG. 3, interconnect path 300 may have an equivalent circuit model 302 that includes some combination of resistors, inductors, and capacitors coupled in series/parallel. In order to efficiently and accurately analyze a high-speed interconnect system, the effects of dispersion, dielectric loss and discontinuities, and other frequency dependent characteristics need to be considered. Thus, frequency domain analysis of interconnect systems may be crucial.

To perform frequency domain analysis of an interconnect, the first step is to generate a frequency domain model of that interconnect. One way of generating a macromodel that describes the relationship of the voltage and current at the input and output terminals of the interconnect system is via a rational approximation method, assuming that any linear time-invariant passive network can be represented using a rational function. An exemplary macromodel expressed in the form of a rational function can be as follows:

$$\frac{output}{input} = \frac{{q}_{0} + {q}_{1} s + {q}_{2} {s}^{2} + {q}_{3} {s}^{3} + … + {q}_{m - 1} {s}^{m - 1} + {q}_{m} {s}^{m}}{{p}_{0} + {p}_{1} s + {p}_{2} {s}^{2} + {p}_{3} {s}^{3} + … + {p}_{n - 1} {s}^{n - 1} + {p}_{n} {s}^{n}} \qquad ( 1 )$$

where pᵢ and qi represent coefficients of the denominator and numerator of the rational function, respectively. A rational function such as the one shown in equation (1) above can be represented using a pole-residue model in the frequency domain. The pole-residue model can be expressed generally as follows:

$${\sum }_{i = 0}^{n} \frac{{k}_{i}}{s + {p}_{i}} + b \qquad ( 2 )$$

where pᵢ represent the poles, where kᵢ represent the residues, and where b represents the real direct proportional constant. The pole-residue frequency domain model as shown in expression (2) can be readily converted to the corresponding time domain equivalent model, which can be expressed generally as follows:

Σₜ₌₀ⁿkᵢe^{-p}^{ᵢ}^{t}+b*u(t) (3)

The pole-residue models, whether the frequency domain model of expression (2) or the time domain model of expression (3), include the necessary information required to characterize any given interconnect system.

The pole-residue model of an interconnect system may be analyzed using analysis tools such as frequency domain analysis tools 402 that is implemented on a circuit design system 400. For example, circuit design system 400 may be based on one or more processors such as personal computers, workstations, etc. The processors may be linked using a network (e.g., a local or wide area network). Memory in these computers or external memory and storage devices such as internal and/or external hard disks or non-transitory computer-read storage media may be used to store instructions and data.

Software-based components such as design tools 402, associated databases, and other computer-aided design or electronic design automation (EDA) tools (not shown) may reside on system 400. During operation, executable software such as the software of computer aided design tools 402 run on the processors of system 400. One or more databases may be used to store data for the operation of system 400. The software may sometimes be referred to as software code, data, program instructions, instructions, script, or code. The non-transitory computer readable storage media may include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s). Software stored on the non-transitory computer readable storage media may be executed on system 400. When the software of system 400 is installed, the storage of system 400 has instructions and data that cause the computing equipment in system 400 to execute various methods (processes). When performing these processes, the computing equipment is configured to implement the functions of circuit design system 400.

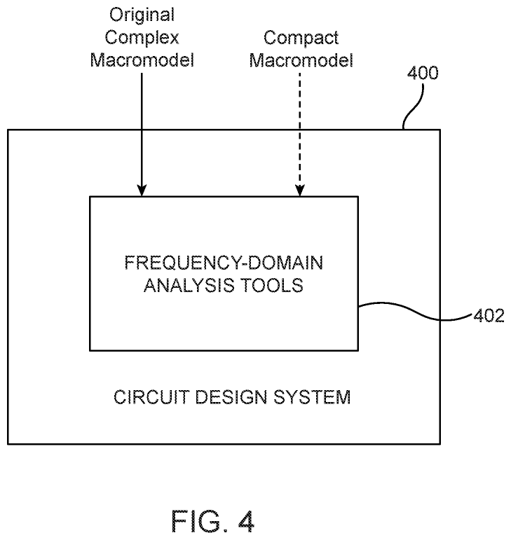

As shown in FIG. 4, analysis tools 402 (sometimes referred to as interconnect analysis tools) may receive an original complex macromodel (i.e., a complex pole-residue model) converted from a rational function such as the one shown in equation (1). The total number of poles that would exist in such pole-residue model can be very large. For instance, integer n in expressions (1)-(3) above that indicate the number/order of the poles may be greater than 50, at least 100, or may be in the hundreds or thousands. In scenarios where the number of poles is this high, the computational time that is needed by analysis tools 402 to perform the desired frequency domain analysis on the complex model can be prohibitively long.

In accordance with an embodiment, a compact macromodel can be obtained from the original complex macromodel, where the compact model is a reduced version of the original complex model while retaining the most significant information from the original model. The compact model may include much fewer poles than the original complex model, which can help dramatically reduce the computational time that is needed at analysis tools 402.

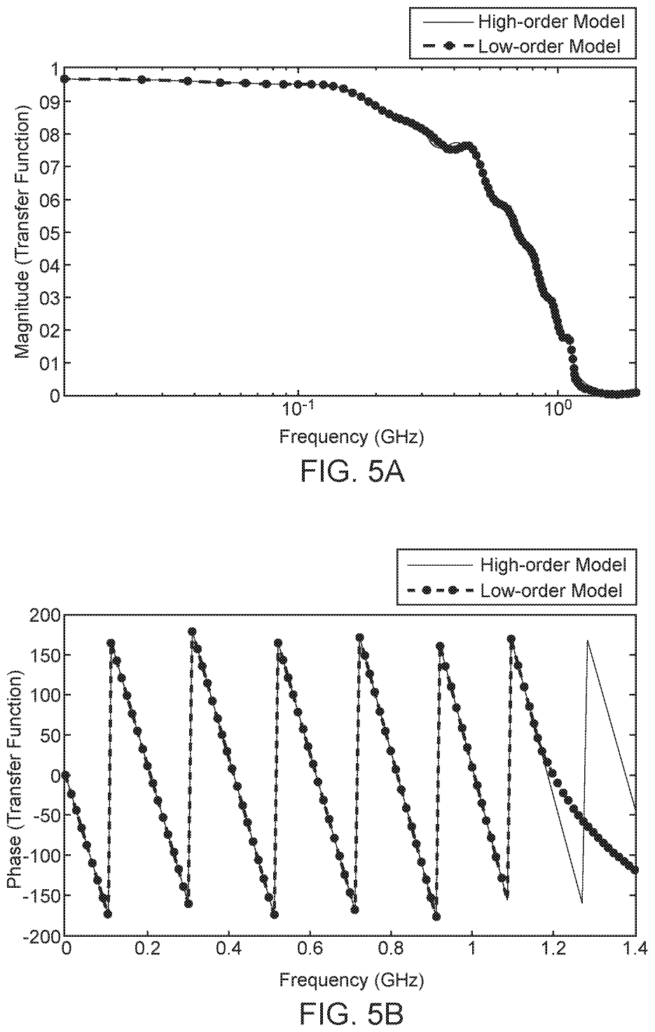

FIGS. 5A and 5B are diagrams illustrating the frequency response of a channel represented using a high-order model and a low-order model. FIG. 5A illustrates the magnitude of the transfer function across frequencies, whereas FIG. 5B illustrates the phase of the transfer function across frequencies. As shown in FIGS. 5A and 5B, the low-order model (i.e., the frequency response provided by the compact pole-residue macromodel) is able to track the high-order model (i.e., the frequency response provided by the original complex pole-residue macromodel) with sufficient accuracy. There may still be some slight deviations at higher frequencies, which are not so consequential as to degrade the overall accuracy or validity of results produced by the analysis tools of FIG. 4.

Conventional methods used to simplify rational functions may rely on interpolation, Padé approximation, or Krylov subspace methods. These approaches, however, require substantial domain expertise and can provide unstable and inaccurate results. The instability and inaccuracy of the results are exacerbated as the order of the interconnect systems increases beyond a hundred or more.

In accordance with an embodiment, a neural network based interconnect autoencoder is provided that is configured to extract only the most significant poles from the original complex model. The extracted subset of poles may be sufficient to accurately represent the interconnect system with minimal error when being analyzed by the analysis tools of FIG. 4. In other works, the term “significant poles” may represent a subset of all poles from the original complex model that is sufficient to represent the behavior of the interconnect system with satisfactory accuracy (see, e.g., FIGS. 5A and 5B). An “autoencoder” may be defined herein as a type of artificial neural network that is used to learn efficiently the hidden relationship in data in an unsupervised manner. This is, however, merely illustrative. If desired, the techniques described may also be extended to neural network architectures based on supervised learning.

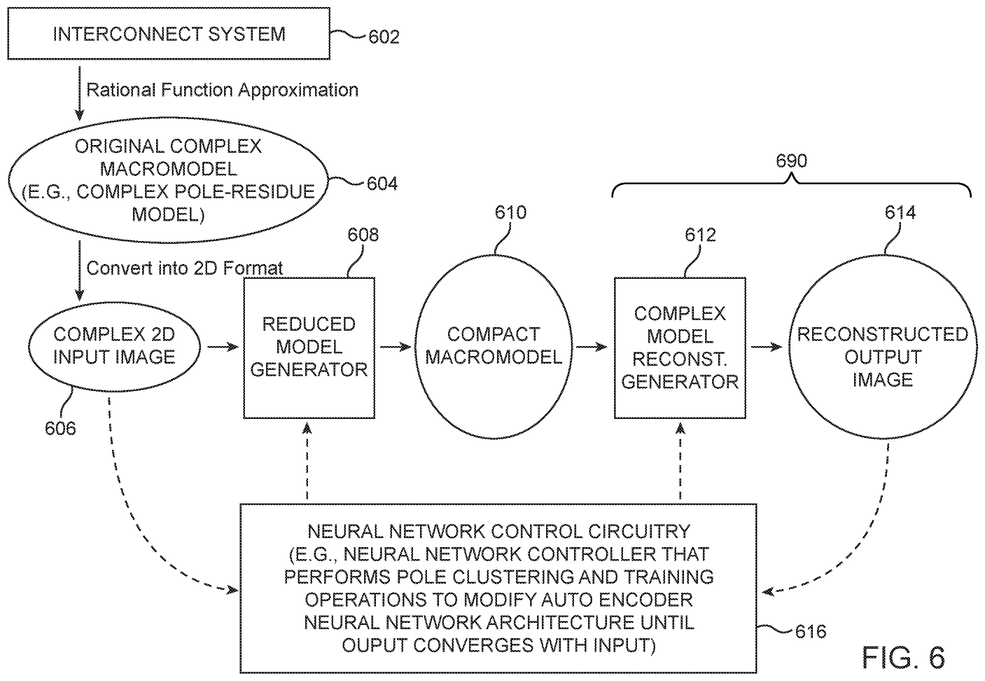

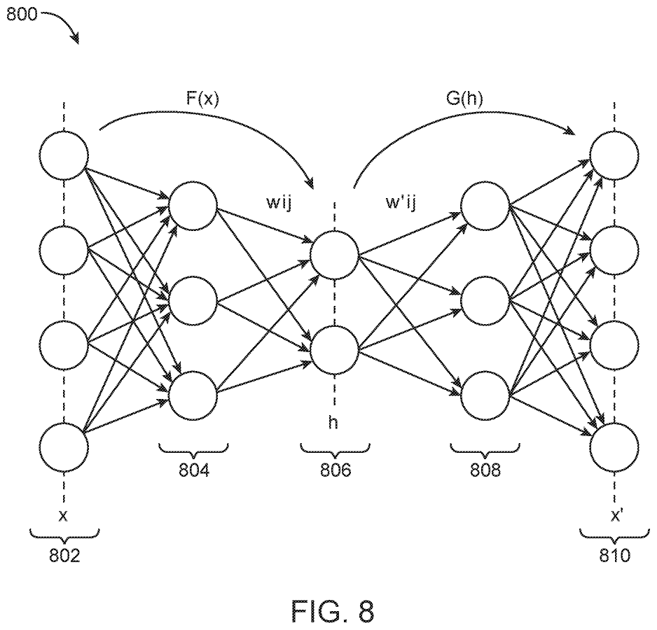

FIG. 6 is a diagram of illustrative autoencoder circuitry configured to generate compact models for enabling efficient and accurate signal and power integrity analysis of high-speed interconnect systems. As shown in FIG. 8, any interconnect system such as interconnect 602 can be received or otherwise obtained as a subject for analysis. The rational function approximation or other suitable transformation method may be used to generate a corresponding original complex macromodel 604 (e.g., a complex pole-residue model) based on the physical characteristics of the interconnect system 602. The complex macromodel, which is typically a high order model having hundreds or thousands of poles, may then optionally be converted into a two-dimensional (2D) format to generate a corresponding complex 2D input image (e.g., a complex input image having real and imaginary pole components).

The 2D image, representing the complex pole and residue in the complex (real and imaginary) plane, may be provided as an input to the autoencoder circuitry. In the example of FIG. 6, the autoencoder circuitry may include a reduced model generator 608 configured to generate a compact model 610 from the input image and may also include a complex model reconstruction generator 612 configured to generate a reconstructed output image 614 from the compact model 610. As described above, the compact model 610 may only be an approximation of the original complex model, the reduction of which may be achieved via dimensionality reduction (e.g., by reducing the total number of poles). The compact model may also sometimes be referred to as the middle layer or the hidden layer.

The reduced model generator 608 may be implemented as a neural network which learns a latent space representation (i.e., a compressed representation with fewer poles) that characterizes the interconnect system with minimal error. The terms latent space representation, compressed representation, and compact (macro)model may be used interchangeability. The complex model reconstruction generator 612 may also be implemented as a neural network that performs the inverse operation of the reduced model generator 608 and that regenerates the original poles in the output image 614 with minimal error. The reduced model generator 608 that converts the input image to the latent space representation may sometimes be referred to as the “encoder” portion of the autoencoder, whereas the model reconstruction generator 612 that reconstructs the output image from the compact representation may sometimes be referred to as the “decoder” portion of the autoencoder.

Arranged in this way, the autoencoder circuitry may be configured to learn the compressed/compact representation for the original complex model so that it can reconstruct from the reduced latent representation an output image as close as possible to the input image (e.g., the autoencoder may be configured to discover correlations in the image input to help preserve features with the most significant frequency response contributions so that the output image converges with the input image) after successful unsupervised training. This may involve training generators 608 and 612 (which are themselves implemented as neural networks) to ignore the insignificant poles while only focusing on the most significant, dominant, influential, or interesting poles/features that are needed to efficiently and accurately characterize the interconnect system. For example, the autoencoder may be trained to map the high-order poles and residues at the input and output of the encoder and decoder neural networks.

The autoencoder circuitry may further include control circuitry 616 that compares the reconstructed output image 614 to the original input image 606 and performs training by modifying the encoder and decoder neural networks as needed to ensure sufficient matching between the input and output images. Control circuitry 616 operated in this way may therefore sometimes be referred to as neural network control circuitry. After successful training, the decoder portion 690 may be discarded while the remaining trained encoder portion may be used generate one or more compact macromodels, which can then be used instead of the original complex model by the frequency domain analysis tools to help reduce the time and cost of running circuit-level simulations and other desired power/signal analysis of interconnect system 602.

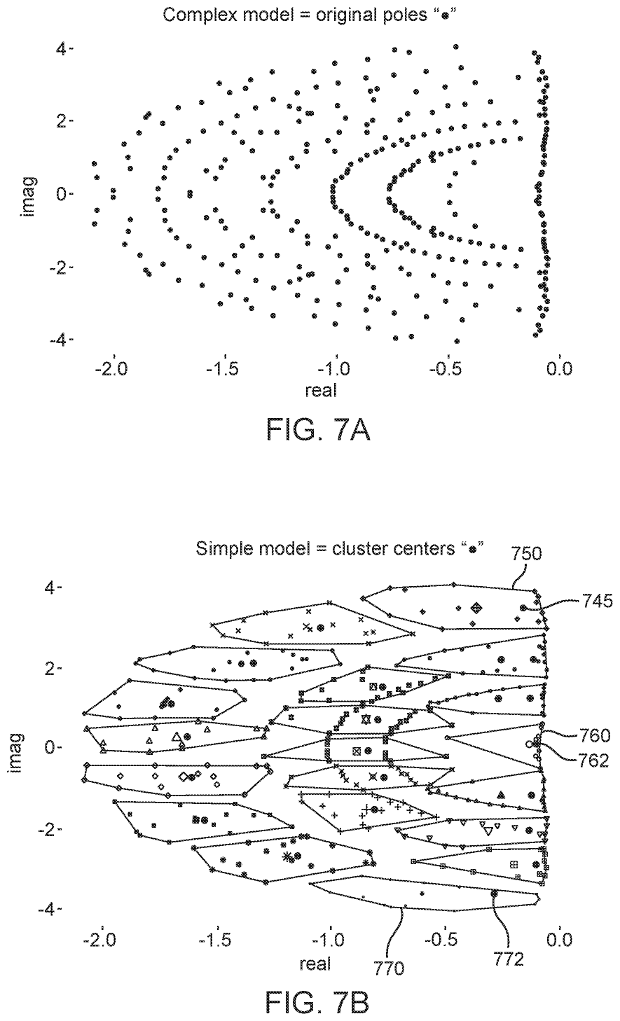

Neural network control circuitry 616 may also be configured to enable the autoencoder circuitry to perform pole clustering prior to or simultaneously with the training operations. FIG. 7A is a diagram illustrating the poles of an exemplary complex macromodel. As shown in FIG. 7A, the complex pole-residue model may include a large number of poles spread across the real and imaginary axes.

FIG. 7B is a diagram illustrating the poles of a simple/compact macromodel reduced from the complex model via clustering in accordance with an embodiment. As shown in FIG. 7B, each group of poles in a particular region may be reduced to a corresponding cluster center. For instance, the poles in region 750 may be simplified to cluster point 752. As another example, the poles in region 760 may be condensed to cluster point 762. As yet another example, the poles in region 770 may be reduced to cluster center 772.

In one suitable embodiment, the clustering may be performed via the inverse distance measure (IDM) clustering technique. The IDM clustering method is merely illustrative. In general, other clustering methods such as K-means clustering, expectation maximization (EM) clustering, hierarchical clustering, spectral clustering, centroid based clustering, connectivity based clustering, density based clustering, subspace clustering, and other suitable clustering techniques may be implemented to help reduce the dimensionality of the input space. The result of these clustering processes helps define the architecture of the encoder and decoder neural networks (e.g., to specify the number of layers and the number of neurons in each layer of the autoencoder for improved accuracy).

FIG. 8 is a diagram showing an illustrative neural network architecture of an autoencoder 800 for performing encoding and decoding operations in accordance with an embodiment. As shown in FIG. 8, autoencoder 800 may have an input layer 802 configured to receive input x (e.g., an original complex model). Input layer 802 may be fed through neurons 804 implementing the encoding function F(x) of the reduced model generator to generate hidden layer h, sometimes also referred to as the middle layer 806. The hidden layer 806 may then be fed through neurons 808 implementing the decoding function G(h) of the complex model reconstruction generator to generate output layer 810 (e.g., a reconstructed output image x′ that converges with original input x after training).

As described above, the clustering operations may generally adjust the structure of the autoencoder neural network (e.g., to modify the number of layers, to modify the number of neurons in each layer, the type of activation function, the connections between the node, etc.). Moreover, the autoencoder may be trained using any suitable training method such as back propagation. Training may generally adjust the coefficients or weights (see, e.g., wᵢⱼ and w′ᵢⱼ) that are used to scale the strength of each neural connection between the various layers. Configured in this way, the clustering operations may provide coarse adjustments to the autoencoder neural network, whereas the training operations may provide relatively finer adjustment to the autoencoder neural network. The use of back propagation to train the autoencoder neural network is merely illustrative. In general, other training methods such as the Gradient Descent method, Newton method, Quasi-Newton method, Conjugate Gradient method, Levenberg-Marquardt method, or other suitable learning algorithms may be used on the interconnect autoencoder circuitry.

The macromodeling of interconnect systems can be performed using various autoencoder architectures including one implemented using a convolutional neural network. Convolutional neural networks extend the basic structure of an autoencoder by using convolutional layers in the neural network. In the example of FIG. 8, the encoding network has convolutional layers including layer 804, whereas the decoding network has transposed convolutional layers including layer 808.

In convolutional autoencoders, the input signal is filtered during the convolutional operation in order to extract some of the information to help better learn the features of the data. The poles and residues of the interconnect macromodels may be complex-conjugate form. The complex poles can be represented in a 2D format (see input 606 in FIG. 6), where the horizontal plane represents the range of real values of the poles and where the vertical plane represents the range of imaginary values of the poles. At each pole position, the corresponding pole data may be stored. Thus, this 2D representation is used as input to the convolutional autoencoder.

In the encoding part, few convolutional layers may be stacked on the input image to extract the significant information. Then, the various convolution units may be flattened in the last convolutional layer to a required size depending on the number of poles required to represent the interconnect system. Operated as such, the input 2D representation is transformed into a latent space representation consisting of the most significant pole information. The encoding portion of the convolutional autoencoder may be expressed as follows:

F(x)=σ(x*W)≡h (4)

where σ represents the activation function, where x denotes the input data, where W represents the filter coefficients, and where * represents the two-dimensional convolutional operation. After training, the latent space (compact) representation h serves as the new representation of the input data.

In the decoding part of the convolutional autoencoder, the transposed convolutional layers may be stacked to reconstruct the input image from the latent space (compressed) representation. In one suitable arrangement, instead of a convolutional layer followed by a pooling layer, the pooling may be replaced with the Inverse Distance Measure (IDM) clustering criterion. The IDM criterion provides larger weights to the poles near the imaginary axis as their effect is more dominant on the system behavior. The pole values may be calculated using the following formula:

$${a}_{i} = {( \frac{1}{n} {\sum }_{i = 1}^{n} \frac{1}{{p}_{i}} )}^{- 1} \qquad ( 5 )$$

where pᵢ are the poles in the pooling layer, where aᵢ are the pole values for a group i calculated using IDM, and where n represent the number of poles in the group. Once the reduced poles are obtained, the residues can be obtained using the same autoencoder neural network using the traditional pooling method. The decoding portion of the convolutional autoencoder may be expressed as follows:

G(h)=σ(h*W′)≡r (6)

where W′ represents the flip or inverse operation over both dimensions of the weights, where σ represents the activation function, where represents the two-dimensional convolutional operation, and where r represents the reconstructed output.

The example described above in which the interconnect autoencoder neural network is implemented as a convolutional autoencoder is merely illustrative and is not intended to limit the scope of the present embodiments. If desired, the interconnect autoencoder circuitry may also be implemented using a multilayer perception neural network, a radial basis function neural network, a recurrent neural network, a long/short-term memory neural network, a feedforward neural network, or other suitable type of neural network.

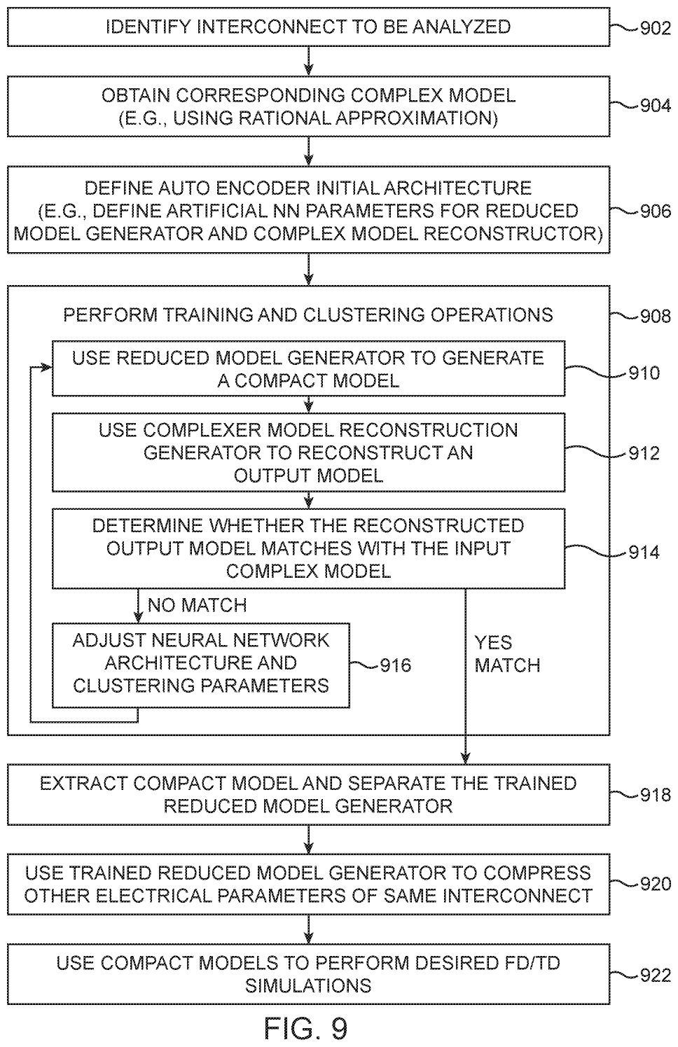

FIG. 9 is a flow chart of illustrative steps involved in operating an interconnect autoencoder of the type described in connection with at least FIGS. 6-8. At step 902, an interconnect system of interest may be identified for analysis. At step 904, a corresponding complex model of the interconnect system may be obtained (e.g., via a rational approximation method). The rational approximation method may produce a rational function (see, e.g., equation 1), which can then be converted to a pole-residue model in the frequency domain or the time domain.

At step 906, the initial architecture of the autoencoder neural network may be defined. For example, the encoder and decoder portions may be initialized to some default neural network configuration with a predetermined number of layers, a predetermined neuron count in each layer, predetermined weights, a predetermined activation function, etc. These settings may sometimes be referred to as artificial neural network architecture parameters.

At step 908, training and clustering operations may be performed. The clustering operations (see, e.g., FIGS. 7A and 7B) may generally be performed prior to or in tandem with the training operations. At step 910, the reduced model generator (i.e., the encoder part of the autoencoder) may receive the original complex model as input and output a corresponding compact model. At step 912, the complex model reconstruction generator may receive the compact model as input and output a corresponding reconstructed output model.

At step 914, the neural network control circuitry may determine whether the reconstructed output model matches or converges with the original complex model. If the error or the amount of mismatch between the two models exceeds a predetermined threshold, the neural network control circuitry may adjust the neural network architecture parameters accordingly to help reduce the error/mismatch (step 916). For example, cluster operations may result in coarse adjustments that modify the overall structure of the artificial neural network (e.g., the number of layers, the number of neurons, etc.), whereas the training operations may result in relatively finer adjustments that modify the values of the weights/coefficients, the neuron connection points, etc. After the adjustments, processing may loop back to step 910 for another iteration.

If the error or the amount of mismatch between the original complex model and the reconstructed output model is less than the predetermined threshold, the autoencoder circuitry has been successfully trained, and processing may proceed to step 918. If the error is not small (i.e., if the error exceeds the predetermined threshold), the autoencoder will loop back to step 908 to repeat the training and clustering. At step 918, the compact model generated by the reduced model generator may be extracted and used at one or more design tools (e.g., the frequency domain analysis tools of FIG. 4) to perform the desired power/signal integrity analysis of the interconnect system. At this point, the decoder portion of the autoencoder circuitry is no longer needed and can be discarded.

The compact model generated and extracted at the end of the training operations may be associated with a given electrical parameter such as S-parameters. At step 920, the trained reduced model generator can now be used to compress other electrical parameters for the same interconnect. As examples, the trained encoder portion may be used to very quickly generate a first additional compact model associated with insertion loss, a second additional compact model associated with return loss, a third additional compact model associated with far-end crosstalk, a fourth additional compact model associated with near-end crosstalk, a fifth additional compact model associated with group delay, a sixth additional compact model associated with propagation constants, or other desired compressed models. At step 922, these compact macromodels (e.g., reduced pole-residue models in the frequency domain or the time domain) may be used in performing the desired frequency domain (FD) or time domain (TD) simulations for the interconnect system of interest.

Although the methods of operations are described in a specific order, it should be understood that other operations may be performed in between described operations, described operations may be adjusted so that they occur at slightly different times or described operations may be distributed in a system which allows occurrence of the processing operations at various intervals associated with the processing, as long as the processing of the overlay operations are performed in a desired way.

### EXAMPLES

The following examples pertain to further embodiments.

Example 1 is a method, comprising: obtaining a complex model of an interconnect; with a reduced model generator, receiving the complex model of the interconnect and outputting a corresponding compact model; with a complex model reconstruction generator, receiving the compact model and outputting a corresponding reconstructed model; with control circuitry, training the reduced model generator and the complex model reconstruction generator so that the reconstructed model converges with the complex model; and after training, using the compact model to perform simulation of the interconnect to reduce computational time.

Example 2 is the method of example 1, wherein the complex model is optionally obtained via rational approximation.

Example 3 is the method of any one of examples 1-2, optionally further comprising: with the control circuitry, comparing the reconstructed model with the complex model to determine an error.

Example 4 is the method of example 3, optionally further comprising: in response to determining that the error between the reconstructed model and the complex model exceeds a predetermined threshold, adjusting the reduced model generator and the complex model reconstruction generator.

Example 5 is the method of example 4, wherein the reduced model generator and the complex model reconstruction generator are optionally implemented as an artificial neural network.

Example 6 is the method of example 5, wherein adjusting the reduced model generator and the complex model reconstruction generator optionally comprises modifying a number of layers in the artificial neural network or modifying a number of neurons in each of the layers in the artificial neural network.

Example 7 is the method of example 5, wherein adjusting the reduced model generator and the complex model reconstruction generator optionally comprises modifying weights in the artificial neural network.

Example 8 is the method of any one of examples 1-7, wherein the complex model comprises a pole-residue model having more than 100 poles, the method optionally further comprising: performing clustering operations on the complex model so that the compact model only includes a smaller number of poles that represent the interconnect with sufficient accuracy.

Example 9 is the method of any one of examples 1-8, optionally further comprising: after training, discarding the complex model reconstruction generator; and using only the reduced model generator to generate additional compact models associated with different electrical parameters selected from the group consisting of: S-parameters, insertion loss, return loss, far-end crosstalk, and near-end crosstalk.

Example 10 is the method of any one of examples 1-9, wherein using the compact model to perform simulation of the interconnect optionally comprises using the compact model to perform frequency domain analysis on the interconnect to reduce computational time.

Example 11 is interconnect autoencoder circuitry, comprising: a reduced model generator configured to receive a complex model of an interconnect system and further configured to output a corresponding compact model of the interconnect system; and a complex model reconstruction generator configured to receive the compact model of the interconnect system and further configured to output a corresponding reconstructed model of the interconnect system.

Example 12 is the interconnect autoencoder circuitry of example 11, wherein the reduced model generator and the complex model reconstruction generator are optionally implemented as an artificial neural network.

Example 13 is the interconnect autoencoder circuitry of example 12, optionally further comprising neural network control circuitry configured to performing clustering operations to reduce a number of poles in the complex model by modifying architecture parameters of the artificial neural network.

Example 14 is the interconnect autoencoder circuitry of example 13, wherein the neural network control circuitry is optionally further configured to performing unsupervised training operations on the artificial neural network until the reconstructed model matches the complex model.

Example 15 is the interconnect autoencoder circuitry of example 14, wherein after the training operations, the reduced model generator is optionally further configured to output additional compact models associated with different electrical parameters for the interconnect system.

Example 16 is a non-transitory computer-readable storage medium comprising instructions to: receive an original complex macromodel of an interconnect system; use the original complex macromodel to output a corresponding latent space representation; use the latent space representation to output a corresponding reconstructed macromodel; and perform training operations until an error between the reconstructed macromodel and the original complex macromodel is below a predetermined threshold.

Example 17 is the non-transitory computer-readable storage medium of example 16, optionally further comprising instructions to: perform clustering operations so that the latent space representation has only significant poles from the original complex macromodel.

Example 18 is the non-transitory computer-readable storage medium of example 17, wherein the instructions to perform the training operations optionally comprise instructions to adjust neural connection weights in an artificial neural network configured to output the latent space representation.

Example 19 is the non-transitory computer-readable storage medium of example 18, wherein the instructions to perform the clustering operations optionally comprise instructions to adjust architecture parameters of the artificial neural network configured to output the latent space representation.

Example 20 is the non-transitory computer-readable storage medium of any one of examples 16-19, optionally further comprising instructions to: use the latent space representation as a compact macromodel of the interconnect system after the training operations; and use the compact macromodel to perform frequency domain analysis on the interconnect system.

For instance, all optional features of the apparatus described above may also be implemented with respect to the method or process described herein. The foregoing is merely illustrative of the principles of this disclosure and various modifications can be made by those skilled in the art. The foregoing embodiments may be implemented individually or in any combination.

What is claimed is:

1. A method, comprising:
obtaining a complex model of an interconnect;
with a reduced model generator, receiving the complex model of the interconnect and outputting a corresponding compact model;
with a complex model reconstruction generator, receiving the compact model and outputting a corresponding reconstructed model;
with control circuitry, training the reduced model generator and the complex model reconstruction generator so that the reconstructed model converges with the complex model; and
after training, using the compact model to perform simulation of the interconnect to reduce computational time.

2. The method of claim 1, wherein the complex model is obtained via rational approximation.

3. The method of claim 1, further comprising:
with the control circuitry, comparing the reconstructed model with the complex model to determine an error.

4. The method of claim 3, further comprising:
in response to determining that the error between the reconstructed model and the complex model exceeds a predetermined threshold, adjusting the reduced model generator and the complex model reconstruction generator.

5. The method of claim 4, wherein the reduced model generator and the complex model reconstruction generator are implemented as an artificial neural network.

6. The method of claim 5, wherein adjusting the reduced model generator and the complex model reconstruction generator comprises modifying a number of layers in the artificial neural network or modifying a number of neurons in each of the layers in the artificial neural network.

7. The method of claim 5, wherein adjusting the reduced model generator and the complex model reconstruction generator comprises modifying weights in the artificial neural network.

8. The method of claim 1, wherein the complex model comprises a pole-residue model having more than 100 poles, the method further comprising:
performing clustering operations on the complex model so that the compact model only includes a smaller number of poles that represent the interconnect with sufficient accuracy.

9. The method of claim 1, further comprising:
after training, discarding the complex model reconstruction generator; and
using only the reduced model generator to generate additional compact models associated with different electrical parameters selected from the group consisting of: S-parameters, insertion loss, return loss, far-end crosstalk, and near-end crosstalk.

10. The method of claim 1, wherein using the compact model to perform simulation of the interconnect comprises using the compact model to perform frequency domain analysis on the interconnect to reduce computational time.

11. Interconnect autoencoder circuitry, comprising:
a reduced model generator configured to receive a complex model of an interconnect system and further configured to output a corresponding compact model of the interconnect system; and
a complex model reconstruction generator configured to receive the compact model of the interconnect system and further configured to output a corresponding reconstructed model of the interconnect system.

12. The interconnect autoencoder circuitry of claim 11, wherein the reduced model generator and the complex model reconstruction generator are implemented as an artificial neural network.

13. The interconnect autoencoder circuitry of claim 12, further comprising neural network control circuitry configured to performing clustering operations to reduce a number of poles in the complex model by modifying architecture parameters of the artificial neural network.

14. The interconnect autoencoder circuitry of claim 13, wherein the neural network control circuitry is further configured to performing unsupervised training operations on the artificial neural network until the reconstructed model matches the complex model.

15. The interconnect autoencoder circuitry of claim 14, wherein after the training operations, the reduced model generator is further configured to output additional compact models associated with different electrical parameters for the interconnect system.

16. A non-transitory computer-readable storage medium comprising instructions to:
receive an original complex macromodel of an interconnect system;
use the original complex macromodel to output a corresponding latent space representation;
use the latent space representation to output a corresponding reconstructed macromodel; and
perform training operations until an error between the reconstructed macromodel and the original complex macromodel is below a predetermined threshold.

17. The non-transitory computer-readable storage medium of claim 16, further comprising instructions to:
perform clustering operations so that the latent space representation has only significant poles from the original complex macromodel.

18. The non-transitory computer-readable storage medium of claim 17, wherein the instructions to perform the training operations comprise instructions to adjust neural connection weights in an artificial neural network configured to output the latent space representation.

19. The non-transitory computer-readable storage medium of claim 18, wherein the instructions to perform the clustering operations comprise instructions to adjust architecture parameters of the artificial neural network configured to output the latent space representation.

20. The non-transitory computer-readable storage medium of claim 16, further comprising instructions to:
use the latent space representation as a compact macromodel of the interconnect system after the training operations; and
use the compact macromodel to perform frequency domain analysis on the interconnect system.
